(19) United States
(12) Patent Application Publication
(10) Pub. No.: US 2007/0248806 A1
(43) Pub. Date: Oct. 25, 2007

(54) Fire Resistent, High Temperature Work Surface

(75) Inventor: Elizabeth N. Kraftician, Wheeling, WV (US)

Correspondence Address: PHILIP D. LANE, P.O. BOX 79318, CHARLOTTE, NC, 28271-7063, US

(73) Assignee: Touchstone Research Laboratory, Ltd., Triadelphia, WV (US)

(21) Appl. No.: 11/379,255

(22) Filed: Apr. 19, 2006

(51) Int. Cl. B32B 3/00

(52) U.S. Cl. 428/312.2

(57) ABSTRACT

A high temperature work surface is described that is resistant to heat and relatively non-reactive to the atmosphere when heat is applied. The work surface may be included in a high temperature work station and may comprise one or more layers of carbonized carbon foam. The carbonized carbon foam may have a thermal conductivity below about 2 W/mK. The work surface may be portable panels or may be incorporated into another surface, table, wall or the like. The work surface may be used to shield surrounding areas from high heat applications.

### BRIEF SUMMARY OF THE INVENTION

A work surface that can withstand exposure to high temperatures and shield or reduce damage to surrounding areas is described. In certain embodiments, the high temperature work surface may be described as a high temperature work table comprising a table top having a top surface adapted to be placed between an object to be exposed to high temperature and an area to be shield from the high temperature. Further, at least a portion of the top surface comprises a carbon foam surface.

Other embodiments of the work surface may include a high temperature work station that comprises a vertical panel comprising carbon foam, and a horizontal floor panel comprising carbon foam positioned near an end of the vertical panel. Further, other embodiments may include a high temperature work station that comprises at least two adjacent vertical panels comprising carbon foam, wherein the at least two adjacent vertical panels form an angle of less than about 180°.

In certain embodiments, the carbon foam used in the work table or work station may have a thermal conductivity below about 1 W/mK. The carbon foam may further have a thickness ranging from about ¼ of an inch to about 2 inches. Still further, the carbon foam may have an electrical resistivity of less than about 1 Ohm-cm. In other embodiments, the carbon foam may have a density ranging from about 0.1 g/cc to about 0.8 g/cc, a compressive strength above about 500 p.s.i., and a thermal conductivity below about 2 W/mK.

### BRIEF DESCRIPTION OF THE DRAWINGS

FIG. 1 is a perspective representation of a fire resistant, high temperature work surface in accordance with an embodiment of the invention.

FIG. 2 is a perspective representation of another embodiment of a fire resistant, high temperature work surface.

FIG. 3 is a representation of still another embodiment of a fire resistant, high temperature work surface.

FIG. 4 is a perspective representation of yet another embodiment of a fire resistant, high temperature work surface.

### DETAILED DESCRIPTION OF EMBODIMENTS OF THE INVENTION

High temperature work surfaces to protect areas from high or intense heat are important for a variety of industries where heat sources are utilized. For example a welder or jeweler when molding, shaping or otherwise working with metal typically utilizes heat sources hot enough to make the metal malleable or workable. If the heat generated from the heat source is not contained, the heat may pose a fire hazard to the area surrounding the heat source or objects being worked on. To this end, a fire resistant work surface is provided that is capable of absorbing or deflecting a significant amount of heat.

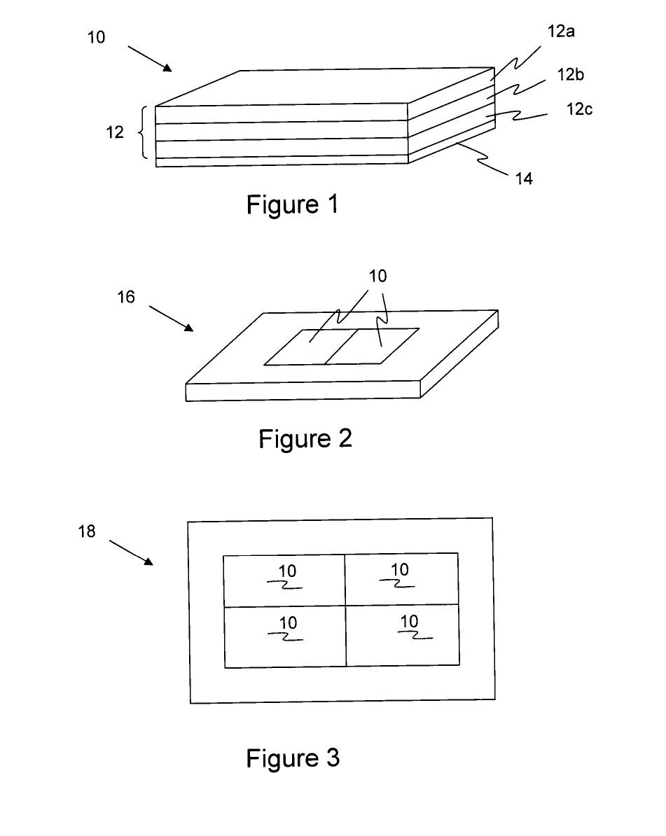

With reference now to FIG. 1, there is illustrated an embodiment of a fire-resistant work surface designated generally by the reference numeral 10. The fire resistant work surface includes a carbon foam layer 12. The carbon foam layer may be composed of one or more layers of carbon foam 12a, 12b, or 12c. There are many types of carbon foam that may be utilized. The carbon foam must be heat resistant and not significantly combust or otherwise significantly degrade when exposed to heat produced by the heat source. The carbon foam may be relatively non-reactive with the atmosphere when exposed to heat generated from the heat source. In some embodiments, the carbon foam may withstand at least 500° C. without significantly combusting or otherwise significantly degrading. In other embodiments, the carbon foam may withstand at least about 1000° C. without significantly combusting or otherwise significantly degrading. The carbon foam typically exhibits a low thermal conductivity. In some embodiments the thermal conductivity is about or below about 2 W/mK, and in certain embodiments, below about 1 W/mK. Other properties of the carbon foam, may include, but are not limited to, having a density that may range from about 0.1 g/cc or greater. In certain embodiments the carbon foam may have a density ranging from about 0.1 g/cc to about 0.8 g/cc. Additionally, the carbon foam may exhibit a compressive strength ranging from about 500 p.s.i. to about 2,000 p.s.i. or higher. In other embodiments, a high density carbon foam having a density above about 0.8 g/cc may be used. In certain embodiments, the high density carbon foam may have a thermal conductivity below about 2 W/mK.

In certain embodiments, the carbon foam may include carbon foam that has been heat treated to an elevated temperature for a period of time sufficient to provide the desired low thermal conductivity and heat resistive properties for the carbon foam layer 12. Typically the carbon foam will be heat treated at temperatures higher than the carbon foam will be exposed to when used as a high temperature work surface or shield. In many embodiments, carbon foam that has been treated to a temperature ranging from about 700° C. to about 1800° C. may yield carbonized carbon foam effective for use in the carbon foam layer 12 of the work surface 10.

Some carbon foams can exhibit electrical resistivities of less than about 1 Ohm-cm, and in some cases less than 0.1 Ohm-cm. Carbon foams exhibiting such low electrical resistivities may also serve as a grounding plate for welding or other similar operations in which a grounding contact is necessary.

Carbon foams for use in the carbon foam layer 12 may be prepared by a variety of known methods. For example, carbon foams may be prepared from particulate coal, coal extracts, petroleum extracts, coal pitches, petroleum pitches, mesophase pitches and materials, or resinous or polymeric foams. These carbon foams may be heat treated to a temperature ranging from about 700° C. to about 1800° C. to provide carbonized carbon foam which may be utilized in the carbon foam layer 12 of the work surface 10.

The dimensions of the carbon foam layer 12 may vary widely depending upon many variables. The intensity of heat generated from the heat source, the size of the area to be protected, and the length of time heat from the heat source is contacting the work surface are just a few of the many variables that may be considered when determining the size, shape, and properties of the work surface.

The thickness of the carbon foam layer 12 is not particularly limited and can vary depending upon the temperature of the heat and the exposure time of the heat to the work surface 10. In some embodiments, the thickness of the carbon foam layer may be at least about a ¼ inch and may range up to about 2 or more inches. Generally the higher the temperature of the heat generated from the heat source and the longer the heat is applied, the thicker the carbon foam layer 12 should be. Further, to get the desired thickness of carbon foam, additional layers of carbon foam 12a, 12b, 12c, may be layered upon one another to form the carbon foam layer 12. In certain embodiments, where the carbonized carbon foam has a thermal conductivity below about 1 W/mK, a 6 inch by 6 inch panel having a thickness of 0.5 inches can withstand temperatures of about 1650° C. without significantly degrading in accordance with ISO 1182.

The length, width, and thickness of the work surface 10 are not particularly limited. The length, width, and thickness may vary from about a ¼ inch to 3 or more feet depending upon the application. For example a jeweler working on a ring or ear ring or other jewelry may only require a work surface large enough to protect the area surrounding the piece of jewelry being worked on. This may only require a work surface that has a length and width of a few inches. A work surface that is six inches long by six inches wide would likely be sufficient. On the other hand a glass blower or welder may require work surfaces that have lengths and widths that are several feet in size to protect larger areas. Further, the shape of the work surface may take on any variety of shapes and configurations. The shapes and configurations will depend upon the heat source and the environment to be protected.

Non-heated surfaces of the carbon foam may optionally be surfaced, covered, or coated with a layer 14 covering a surface of the carbon foam layer 12. The layer 14, if desired, helps provide strength and stiffness to the carbonized carbon foam layer and may also provide for points of attachment to other surfaces or objects. The layer 14 may comprise any variety of materials, including but not limited to resins or polymers, paint, metals, polymeric composites, metallic composites, wood, and other similar materials. The material for the layer 14 should be capable of withstanding temperatures reached by the carbonized carbon foam surface adjacent to the support layer 14. Further, the heated surface of the carbon foam may be surfaced with a layer of heat resistant material 15. The heat resistant material may include, but is not limited to ceramics, metals, and other similar materials.

The work surface 10 may be a panel that is portable and can be positioned where desired. Alternatively, as shown in FIG. 2, one or more work surfaces 10 may be incorporated into a portion of a table 16. Further, as shown in FIG. 3, the one or more work surfaces 10 may be incorporated into a portion of a wall 18.

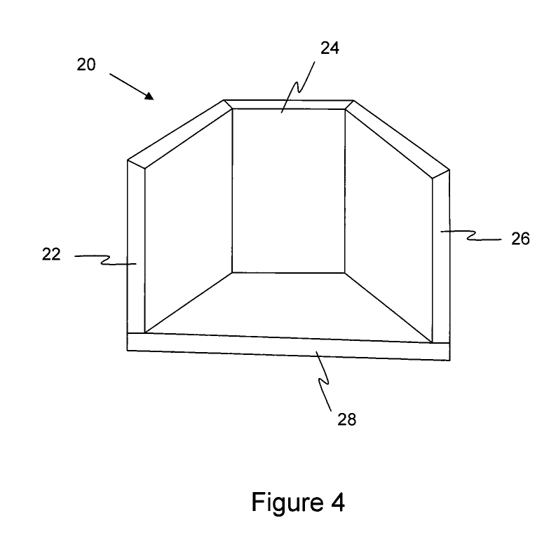

With reference now to FIG. 4, there is shown a high temperature work station 20. The embodiment shown in FIG. 4 includes a plurality of carbon foam containing relatively vertical panels, three such panels are designated as reference numerals 22, 24, and 26. The vertical panels may be permanently attached in a desired configuration by an adhesive or by known mechanical fastening techniques. Alternatively, the vertical panels may be reversibly connected to one another by conventional techniques including, but not limited to, tongue and groove joinery, attachment pins, or other similar techniques. The vertical configuration of the panels provides surfaces that may withstand high temperatures and minimize exposing the surrounding environment to heat generated from a directional heat source such as a hand held torch or welding arc where the direction of the heat source is highly variable. The angle of the vertical panels is not particularly limited. The vertical panels may be positioned at any desirable vertical angle with respect to a floor panel 28 or other relatively horizontal surface. Further the vertical panels may be positioned at any angle with respect to one another. The number of vertical panels is not particularly limited and will depend on the application and surrounding environment to be shield from the heat source. Certain embodiments include at least one vertical panel. Other embodiments include at least two vertical panels. Optionally a horizontal floor panel 28 containing carbon foam may be provided to further protect surrounding areas from a heat source. Further the horizontal floor panel 28 may provide a surface to support the work piece.

Having described several embodiments in detail, the invention is broadly applicable and only limited by the scope of the appended claims.

What is claimed is:

1. A high temperature work station comprising:
a vertical panel comprising carbon foam; and
a horizontal floor panel comprising carbon foam positioned near an end of the vertical panel.

2. The high temperature work station of claim 1, wherein the carbon foam has a thermal conductivity below about 1 W/mK.

3. The high temperature work station of claim 1, wherein the carbon foam has a thickness ranging from about ¼ of an inch to about 2 inches.

4. The high temperature work station of claim 1, wherein the carbon foam has an electrical resistivity of less than about 1 Ohm-cm.

5. The high temperature work station of claim 1, wherein the carbon foam has a density ranging from about 0.1 g/cc to about 0.8 g/cc, a compressive strength above about 500 p.s.i., and a thermal conductivity below about 2 W/mK.

6. A high temperature work station comprising:
at least two adjacent vertical panels comprising carbon foam, wherein the at least two adjacent vertical panels form an angle of less than about 180°.

7. The high temperature work station of claim 6, wherein the carbon foam has a thermal conductivity below about 1 W/mK.

8. The high temperature work station of claim 6, wherein the carbon foam has a thickness ranging from about ¼ of an inch to about 2 inches.

9. The high temperature work station of claim 6, wherein the carbon foam has an electrical resistivity of less than about 1 Ohm-cm.

10. The high temperature work station of claim 6, wherein the carbon foam has a density ranging from about 0.1 g/cc to about 0.8 g/cc, a compressive strength above about 500 p.s.i., and a thermal conductivity below about 2 W/mK.

11. A high temperature work station comprising:
a table top comprising a top surface adapted to be placed between an object to be exposed to high temperature and an area to be shield from the high temperature, wherein at least a portion of the top surface comprises a carbon foam surface.

12. The high temperature work station of claim 11, wherein the carbon foam has a thermal conductivity below about 1 W/mK.

13. The high temperature work station of claim 11, wherein the carbon foam has a thickness ranging from about ¼ of an inch to about 2 inches.

14. The high temperature work station of claim 11, wherein the carbon foam has an electrical resistivity of less than about 1 Ohm-cm.

15. The high temperature work station of claim 11, wherein the carbon foam has a density ranging from about 0.1 g/cc to about 0.8 g/cc, a compressive strength above about 500 p.s.i., and a thermal conductivity below about 2 W/mK.

16. The high temperature work station of claim 11, wherein said table top comprises more than one panel of carbon foam.

17. The high temperature work station of claim 11, wherein said table top comprises more than one layer of carbon foam.
